(19) United States
(12) Patent Application Publication
(10) Pub. No.: US 2010/0160187 A1
(43) Pub. Date: Jun. 24, 2010

(54) Methods and compositions for stabilizing unconsolidated particulates in a subterranean formation

(75) Inventors: Philip D. Nguyen, Duncan, OK (US); Richard D. Rickman, Duncan, OK (US); Ronald G. Dusterhoft, Katy, TX (US)

Correspondence Address: ROBERT A. KENT, P.O. BOX 1431, DUNCAN, OK, 73536, US

(73) Assignee: Halliburton Energy Services, Inc.

(21) Appl. No.: 12/316,926

(22) Filed: Dec. 18, 2008

(51) Int. Cl. C09K 8/60

(52) U.S. Cl. 507/202; 507/220; 507/221; 507/224; 507/233

(57) ABSTRACT

Methods and compositions for stabilizing portions of a subterranean formation that comprise unconsolidated particulates are provided. In one embodiment, a method of treating a subterranean formation includes introducing a pre-flush fluid into a subterranean formation comprising unconsolidated particulates; introducing a foamed consolidation fluid comprising an aqueous base fluid, an emulsified resin, a hardening agent, a silane coupling agent, and a surfactant into the subterranean formation subsequent to the pre-flush fluid; wherein the emulsified resin is emulsified prior to being introduced into the aqueous base fluid; and allowing the resin to cure to at least partially consolidate the unconsolidated particulates.

### BACKGROUND

The present invention relates to methods and compositions for treating subterranean formations. More particularly, the present invention relates to methods and compositions for stabilizing portions of a subterranean formation that comprise unconsolidated particulates.

Hydrocarbon-producing wells are often stimulated by hydraulic fracturing treatments. Hydraulic fracturing operations generally involve pumping a fracturing fluid into a well bore that penetrates a subterranean formation at a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation. The fracturing fluid may comprise particulates, often referred to as “proppant particulates,” that are deposited in the fractures. The proppant particulates function, inter alia, to prevent the fractures from fully closing upon the release of hydraulic pressure, forming conductive channels through which fluids may flow to the well bore. After at least one fracture is created and the proppant particulates are substantially in place, the fracturing fluid may be “broken” (i.e., the viscosity of the fluid is reduced), and the fracturing fluid may be recovered from the formation.

Hydrocarbon-producing wells also may undergo gravel packing treatments, inter alia, to reduce the migration of unconsolidated formation particulates into the well bore. In gravel-packing treatments, a treatment fluid suspends particulates (commonly referred to as “gravel particulates”) to be deposited in a desired area in a well bore, e.g., near unconsolidated or weakly consolidated formation zones, to form a gravel pack to enhance sand control. One common type of gravel-packing operation involves placing a sand control screen in the well bore and packing the annulus between the screen and the well bore with the gravel particulates of a specific size designed to prevent the passage of formation sand. The gravel particulates act, inter alia, to prevent the formation particulates from occluding the screen or migrating with the produced hydrocarbons, and the screen acts, inter alia, to prevent the particulates from entering the production tubing. Once the gravel pack is substantially in place, the viscosity of the treatment fluid may be reduced to allow it to be recovered.

In some situations, fracturing and gravel-packing treatments are combined into a single treatment (commonly referred to as “frac pack” operations). In such “frac pack” operations, the treatments are generally completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack.

Occasionally, sand, gravel, proppant, and/or other unconsolidated particulates placed in the subterranean formation during a fracturing, gravel packing, or frac pack operation may migrate out of the subterranean formation into a well bore and/or may be produced with the oil, gas, water, and/or other fluids produced by the well. The presence of such particulates, in produced fluids is undesirable in that the particulates may abrade pumping and other producing equipment and/or reduce the production of desired fluids from the well. Moreover, particulates that have migrated into a well bore (e.g., inside the casing and/or perforations in a cased hole), among other things, may clog portions of the well bore, hindering the production of desired fluids from the well. The term “unconsolidated particulates,” and derivatives thereof, is defined herein to include loose particulates and particulates bonded with insufficient bond strength to withstand the forces created by the production of fluids through the formation. Unconsolidated particulates may comprise, among other things, sand, gravel, fines and/or proppant particulates in the subterranean formation.

One method of controlling unconsolidated particulates has been to produce fluids from the formations at low flow rates. The production of unconsolidated particulates may still occur, however, due to unintentionally high production rates and/or pressure cycling as may occur from repeated shut-ins and start ups of a well. Moreover, producing fluids from the formations at low flow rates may prove economically inefficient or unfeasible.

Another technique used to control unconsolidated particulates has been to coat the particulates with a tackifying agent or curable resin prior to their introduction into the subterranean formation and allowing the tackifying agent or resin to consolidate the particulates once inside the formation. In general, the tackifying agent or resin enhances the grain-to-grain, or grain-to-formation, contact between particulates and/or subterranean formation so that the particulates are stabilized, locked in place, or at least partially immobilized such that they are resistant to flowing with produced or injected fluids. Applying a resin or tackifying agent to the particulate matter prior to introduction into the subterranean formation, however, may be inefficient in that the resin or tackifying agent on particulates placed further into a fracture may be unnecessary since sufficient consolidation may be achieved, in some instances, by consolidating only the particulate matter nearest to the well bore. Furthermore, pre-coating may be ineffective to remediate particulates that have been placed in the formation and subsequently become unconsolidated.

Yet another technique used to control particulates in unconsolidated formations involves application of a consolidation fluid containing resins or tackifying agents to consolidate particulates into a stable, permeable mass after their placement in the subterranean formation. These consolidation fluids may be preferentially placed in a particular region of a subterranean formation using isolation tools, such as “pack off” devices, packers, gel plugs, mechanical plugs, bridge plugs, ball sealers, and the like. However, previous solvent-based consolidation fluids may exhibit low flash points, pose environmental and/or safety concerns, and/or adversely affect other treatment fluids.

### SUMMARY

The present invention relates to methods and compositions for treating subterranean formations. More particularly, the present invention relates to methods and compositions for stabilizing portions of a subterranean formation that comprise unconsolidated particulates.

In one embodiment of the present invention, a consolidation fluid comprises an aqueous base fluid, an emulsified resin, a hardening agent, a silane coupling agent, and a surfactant; wherein the emulsified resin is emulsified prior to being introduced into the aqueous base fluid.

In another embodiment of the present invention, a method of treating a subterranean formation comprises introducing a consolidation fluid comprising an aqueous base fluid, an emulsified resin, and a hardening agent into a subterranean formation comprising unconsolidated particulates; wherein the emulsified resin is emulsified prior to being introduced into the aqueous base fluid; and allowing the resin to cure to at least partially consolidate the unconsolidated particulates.

In yet another embodiment of the present invention, a method of treating a subterranean formation comprises introducing a pre-flush fluid into a subterranean formation comprising unconsolidated particulates; introducing a foamed consolidation fluid comprising an aqueous base fluid, an emulsified resin, a hardening agent, a silane coupling agent, and a surfactant into the subterranean formation subsequent to the pre-flush fluid; wherein the emulsified resin is emulsified prior to being introduced into the aqueous base fluid; and allowing the resin to cure to at least partially consolidate the unconsolidated particulates.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to methods and compositions for treating subterranean formations. More particularly, the present invention relates to methods and compositions for stabilizing portions of a subterranean formation that comprise unconsolidated particulates.

The subterranean formations treated using the methods and compositions of the present may be any subterranean formation wherein unconsolidated particulates reside in the formation. These unconsolidated particulates may comprise, among other things, sand, gravel, fines and/or proppant particulates within the open space of one or more fractures in the subterranean formation (e.g., unconsolidated particulates that form a proppant pack or gravel pack within the formation). Using the consolidation fluids and methods of the present invention, the unconsolidated particulates with the formation may be remedially treated to consolidate the particulates into a cohesive, consolidated, yet permeable pack and minimize or reduce their production with production fluids.

One of the advantages of some embodiments of the present invention, many of which are not discussed herein, is that the consolidation fluids of the present invention are aqueous and may be cleaned up with water. The fluids may also pose fewer compatibility issues with other treatment fluids. Additionally, in some embodiments of the present invention, the consolidation fluids may have higher flashpoints than previous consolidation fluids, posing less of an environmental and/or safety risk. Furthermore, in some embodiments, the consolidation fluids may be foamed for diverting, which may help overcome low bottomhole pressures that may cause excessive fluid loss in high permeability intervals, thus helping to evenly distribute the treatment fluid and facilitate the treatment of long intervals.

The consolidation fluids of the present invention generally comprise an aqueous base, an emulsified resin, and a hardening agent. In some embodiments, the consolidation fluid may also comprise a surfactant and/or a silane coupling agent.

The aqueous base fluids used in the consolidation fluids of the present invention may comprise fresh water, saltwater (e.g., water containing one or more salts dissolved therein), brine (e.g., saturated saltwater), seawater, or combinations thereof, and may be from any source, provided that they do not contain components that might adversely affect the stability and/or performance of the consolidation fluids of the present invention.

The consolidation fluids of the present invention also include an emulsified resin. The term “resin” as used herein refers to any of numerous physically similar polymerized synthetics or chemically modified natural resins including thermoplastic materials and thermosetting materials. In some embodiments, the resin may be emulsified prior to being suspended or dispersed in the aqueous base fluid. Furthermore, in some embodiments the resin may be present in the consolidation fluid without the use of a solvent to alter the viscosity of the resin. Due to the absence of such a solvent, in particular embodiments the fluids may exhibit higher flash points and pose fewer environmental, safety, and/or compatibility concerns than consolidation fluids comprising a solvent.

Emulsified resins suitable for use in the consolidation fluids of the present invention may include all resins known in the art that are capable of forming a hardened, consolidated mass. The resins may enhance the grain-to-grain contact between the individual particulates within the formation, helping bring about the consolidation of the particulates into a cohesive and permeable mass. Many such resins are commonly used in subterranean consolidation operations, and some suitable resins include two-component epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof. Some suitable resins, such as epoxy resins, may be cured with an internal catalyst or activator so that when pumped down hole, they may be cured using only time and temperature. Other suitable resins, such as furan resins generally require a time-delayed catalyst or an external catalyst to help activate the polymerization of the resins if the cure temperature is low (i.e., less than 250° F.), but will cure under the effect of time and temperature if the formation temperature is above about 250° F., preferably above about 300° F. It is within the ability of one skilled in the art, with the benefit of this disclosure, to select a suitable resin for use in embodiments of the present invention and to determine whether a catalyst is required to trigger curing.

Selection of a suitable resin may be affected by the temperature of the subterranean formation to which the fluid will be introduced. By way of example, for subterranean formations having a bottom hole static temperature (“BHST”) ranging from about 60° F. to about 250° F., two-component epoxy-based resins comprising a hardenable resin component and a hardening agent component containing specific hardening agents may be preferred. For subterranean formations having a BHST ranging from about 300° F. to about 600° F., a furan-based resin may be preferred. For subterranean formations having a BHST ranging from about 200° F. to about 400° F., either a phenolic-based resin or a one-component HT epoxy-based resin may be suitable. For subterranean formations having a BHST of at least about 175° F., a phenol/phenol formaldehyde/furfuryl alcohol resin may also be suitable.

Generally, the emulsified resin may be present in the consolidation fluid in an amount from about 0.1% w/v to about 20% w/v. In some embodiments, the emulsified resin is present in the consolidation fluid in an amount from about 1% w/v to about 10% w/v. In particular embodiments, the emulsified resin is present in the consolidation fluid in an amount from about 3% w/v to about 6% w/v.

As mentioned above, in some embodiments, the emulsified resin may be emulsified prior to being suspended or dispersed in the aqueous base fluid. By using a resin emulsified prior to being suspended or dispersed in the aqueous base fluid, particular embodiments of the present invention may offer the advantage of easier handling and require less preparation in the field. Examples of suitable emulsifying agents may include surfactants, proteins, hydrolyzed proteins, lipids, glycolipids, and nano-sized particulates, such as fumed silica.

Surfactants suitable for pre-emulsifying the resin include those capable of emulsifying an organic based component in an aqueous based component so that the emulsion has an aqueous external phase and an organic internal phase. In some embodiments, the surfactant may comprise an amine surfactant. Such amine surfactants include, but are not limited to, amine ethoxylates and amine ethoxylated quaternary salts such as tallow diamine and tallow triamine exthoxylates and quaternary salts. Examples of other suitable surfactants include, but are not limited to, ethoxylated C₁₂-C₂₂ diamine, ethoxylated C₁₂-C₂₂ triamine, ethoxylated C₁₂-C₂₂ tetraamine, ethoxylated C₁₂-C₂₂ diamine methylchloride quat, ethoxylated C₁₂-C₂₂ triamine methylchloride quat, ethoxylated C₁₂-C₂₂ tetraamine methylchloride quat, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine DDBSA salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ tetraamine DDBSA salt, pentamethylated C₁₂-C₂₂ diamine quat, heptamethylated C₁₂-C₂₂ diamine quat, nonamethylated C₁₂-C₂₂ diamine quat, and combinations thereof.

In some embodiments of the present invention, an amine surfactant suitable as an emulsifying agent may have the general formula:

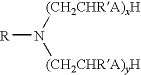

wherein R is a C₁₂-C₂₂ aliphatic hydrocarbon; R′ is independently selected from hydrogen or C₁ to C₃ alkyl group; A is independently selected from NH or O, and x+y has a value greater than or equal to one but also less than or equal to three. In some embodiments, the R group is a non-cyclic aliphatic. In some embodiments, the R group may contain at least one degree of unsaturation, i.e., at least one carbon-carbon double bond. In other embodiments, the R group may be a commercially recognized mixture of aliphatic hydrocarbons such as soya, which is a mixture of C₁₄ to C₂₀ hydrocarbons, or tallow which is a mixture of C₁₆ to C₂₀ aliphatic hydrocarbons, or tall oil which is a mixture of C₁₄ to C₁₈ aliphatic hydrocarbons. In other embodiments, one in which the A group is NH, the value of x+y is preferably two, with x having a preferred value of one. In other embodiments, in which the A group is O, the preferred value of x+y is two, with the value of x being preferably one. One example of a commercially available amine surfactant is TER 2168 Series available from Champion Chemicals located in Fresno, Tex. Other commercially available examples include ETHOMEEN T/12, a diethoxylated tallow amine; ETHOMEEN S/12, a diethoxylated soya amine; DUOMEEN O, a N-oleyl-1,3-diaminopropane; DUOMEEN T, a N-tallow-1,3-diaminopropane; all of which are commercially available from Akzo Nobel.

In other embodiments, the surfactant may be a tertiary alkyl amine ethoxylate (a cationic surfactant). TRITON RW-100 surfactant (x+y=10 moles of ethylene oxide) and TRITON RW-150 surfactant (x+y=15 moles of ethylene oxide) are examples of tertiary alkyl amine ethoxylates that are commercially available from Dow Chemical Company.

In other embodiments, the surfactant may be a combination of an amphoteric surfactant and an anionic surfactant. In some embodiments, the relative amounts of the amphoteric surfactant and the anionic surfactant in the emulsifying agent may be of about 30% to about 45% by weight of the surfactant mixture and of about 55% to about 70% by weight of the surfactant mixture, respectively. The amphoteric surfactant may be lauryl amine oxide, a mixture of lauryl amine oxide and myristyl amine oxide (i.e., a lauryl/myristyl amine oxide), cocoamine oxide, lauryl betaine, oleyl betaine, or combinations thereof, with the lauryl/myristyl amine oxide being preferred. The cationic surfactant may be cocoalkyltriethyl ammonium chloride, hexadecyltrimethyl ammonium chloride, or combinations thereof, with a 50/50 mixture by weight of the cocoalkyltriethyl ammonium chloride and the hexadecyltrimethyl ammonium chloride being preferred.

In other embodiments, the emulsifying agent may be a nonionic surfactant. Examples of suitable nonionic surfactants include, but are not limited to, alcohol oxylalkylates, alkyl phenol oxylalkylates, nonionic esters, such as sorbitan esters, and alkoxylates of sorbitan esters. Examples of suitable surfactants include, but are not limited to, castor oil alkoxylates, fatty acid alkoxylates, lauryl alcohol alkoxylates, nonylphenol alkoxylates, octylphenol alkoxylates, tridecyl alcohol alkoxylates, such as polyoxyethylene (“POE”)-10 nonylphenol ethoxylate, POE-100 nonylphenol ethoxylate, POE-12 nonylphenol ethoxylate, POE-12 octylphenol ethoxylate, POE-12 tridecyl alcohol ethoxylate, POE-14 nonylphenol ethoxylate, POE-15 nonylphenol ethoxylate, POE-18 tridecyl alcohol ethoxylate, POE-20 nonylphenol ethoxylate, POE-20 oleyl alcohol ethoxylate, POE-20 stearic acid ethoxylate, POE-3 tridecyl alcohol ethoxylate, POE-30 nonylphenol ethoxylate, POE-30 octylphenol ethoxylate, POE-34 nonylphenol ethoxylate, POE-4 nonylphenol ethoxylate, POE-40 castor oil ethoxylate, POE-40 nonylphenol ethoxylate, POE-40 octylphenol ethoxylate, POE-50 nonylphenol ethoxylate, POE-50 tridecyl alcohol ethoxylate, POE-6 nonylphenol ethoxylate, POE-6 tridecyl alcohol ethoxylate, POE-8 nonylphenol ethoxylate, POE-9 octylphenol ethoxylate, mannide monooleate, sorbitan isostearate, sorbitan laurate, sorbitan monoisostearate, sorbitan monolaurate, sorbitan monooleate, sorbitan monopalmitate, sorbitan monostearate, sorbitan oleate, sorbitan palmitate, sorbitan sesquioleate, sorbitan stearate, sorbitan trioleate, sorbitan tristearate, POE-20 sorbitan monoisostearate ethoxylate, POE-20 sorbitan monolaurate ethoxylate, POE-20 sorbitan monooleate ethoxylate, POE-20 sorbitan monopalmitate ethoxylate, POE-20 sorbitan monostearate ethoxylate, POE-20 sorbitan trioleate ethoxylate, POE-20 sorbitan tristearate ethoxylate, POE-30 sorbitan tetraoleate ethoxylate, POE-40 sorbitan tetraoleate ethoxylate, POE-6 sorbitan hexastearate ethoxylate, POE-6 sorbitan monstearate ethoxylate, POE-6 sorbitan tetraoleate ethoxylate, and/or POE-60 sorbitan tetrastearate ethoxylate. Suitable nonionic surfactants include alcohol oxyalkyalates, such as POE-23 lauryl alcohol, and alkyl phenol ethoxylates, such as POE (20) nonyl phenyl ether.

While cationic, amphoteric, and nonionic surfactants are commonly used, any suitable emulsifying agent may be used to emulsify the resin in accordance with the teachings of the present invention. Good surfactants for emulsification typically need to be either ionic, to give charge stabilization, to have a sufficient hydrocarbon chain length or cause a tighter packing of the hydrophobic groups at the oil/water interface to increase the stability of the emulsion. One of ordinary skill in the art with the benefit of this disclosure will be able to select a suitable surfactant depending upon the resin that is being emulsified. Additional suitable surfactants may include other cationic surfactants and even anionic surfactants. Examples include, but are not limited to, hexahydro-1 3,5-tris(2-hydroxyethyl)triazine, alkyl ether phosphate, ammonium lauryl sulfate, ammonium nonylphenol ethoxylate sulfate, branched isopropyl amine dodecylbenzene sulfonate, branched sodium dodecylbenzene sulfonate, dodecylbenzene sulfonic acid, branched dodecylbenzene sulfonic acid, fatty acid sulfonate potassium salt, phosphate esters, POE-1 ammonium lauryl ether sulfate, OE-1 sodium lauryl ether sulfate, POE-10 nonylphenol ethoxylate phosphate ester, POE-12 ammonium lauryl ether sulfate, POE-12 linear phosphate ester, POE-12 sodium lauryl ether sulfate, POE-12 tridecyl alcohol phosphate ester, POE-2 ammonium lauryl ether sulfate, POE-2 sodium lauryl ether sulfate, POE-3 ammonium lauryl ether sulfate, POE-3 disodium alkyl ether sulfosuccinate, POE-3 linear phosphate ester, POE-3 sodium lauryl ether sulfate, POE-3 sodium octylphenol ethoxylate sulfate, POE-3 sodium tridecyl ether sulfate, POE-3 tridecyl alcohol phosphate ester, POE-30 ammonium lauryl ether sulfate, POE-30 sodium lauryl ether sulfate, POE-4 ammonium lauryl ether sulfate, POE-4 ammonium nonylphenol ethoxylate sulfate, POE-4 nonyl phenol ether sulfate, POE-4 nonylphenol ethoxylate phosphate ester, POE-4 sodium lauryl ether sulfate, POE-4 sodium nonylphenol ethoxylate sulfate, POE-4 sodium tridecyl ether sulfate, POE-50 sodium lauryl ether sulfate, POE-6 disodium alkyl ether sulfosuccinate, POE-6 nonylphenol ethoxylate phosphate ester, POE-6 tridecyl alcohol phosphate ester, POE-7 linear phosphate ester, POE-8 nonylphenol ethoxylate phosphate ester, potassium dodecylbenzene sulfonate, sodium 2-ethyl hexyl sulfate, sodium alkyl ether sulfate, sodium alkyl sulfate, sodium alpha olefin sulfonate, sodium decyl sulfate, sodium dodecylbenzene sulfonate, sodium lauryl sulfate, sodium lauryl sulfoacetate, sodium nonylphenol ethoxylate sulfate, and/or sodium octyl sulfate.

Other suitable emulsifying agents are described in U.S. Pat. Nos. 6,653,436 and 6,956,086, both issued to Back et al., the disclosures of which are herein incorporated by reference.

In some embodiments, the emulsifying agent may be present in the consolidation fluid in an amount in the range of about 0.001% to about 10% by weight of the consolidation fluid. In some embodiments, the emulsifying agent may be present in the consolidation fluid in an amount in the range of about 0.05% to about 5% by weight of the consolidation fluid.

Generally, the emulsified resin may be provided in any suitable form, including particle form, which may be solid and/or liquid. In those embodiments where the resin is provided in a particle form, the size of the particle can vary widely. In some embodiments, the resin particles may have an average particle diameter of about 0.01 micrometers (“μm”) to about 500 μm. In some embodiments, the resin particles may have an average particle diameter of about 0.1 μm to about 100 μm. In some embodiments, the resin particles may have an average particle diameter of about 0.5 μm to about 10 μm. The size distribution of the resin particles used in a particular composition or method may depend upon several factors including, but not limited to, the size distribution of the particulates present in the subterranean formation, the effective porosity and/or permeability of the subterranean formation, pore throat size and distribution, and the like.

In some embodiments, it may be desirable to use a resin with a particle size distribution such that the resin particles are placed at contact points between formation particulates. For example, in some embodiments, the size distribution of the resin particles may be within a smaller size range, e.g., from about 0.5 μm to about 10 μm. It may be desirable in some embodiments to provide resin particles with a smaller size distribution, inter alia, to promote deeper penetration of the resin through a body of unconsolidated particulates or in low permeability formations.

In other embodiments, the size distribution of the resin particles may be within a larger range, e.g., from about 50 μm to about 500 μm. It may be desirable in some embodiments to provide resin particles with a larger size distribution, inter alia, to promote the filtering out of resin particles at or near the spaces between neighboring unconsolidated particulates or in high permeability formations. A person of ordinary skill in the art, with the benefit of this disclosure, will be able to select an appropriate particle size distribution for the resin particles suitable for use in accordance with the teachings of the present invention and will appreciate that methods of creating resin particles of any relevant size are well known in the art.

The consolidation fluids of the present invention may also include a hardening agent, which serves to transform the resin into a hardened, consolidated mass. Examples of suitable hardening agents include, but are not limited to, piperazine, derivatives of piperazine (e.g., aminoethylpiperazine), 2H-pyrrole, pyrrole, imidazole, pyrazole, pyridine, pyrazine, pyrimidine, pyridazine, indolizine, isoindole, 3H-indole, indole, 1H-indazole, purine, 4H-quinolizine, quinoline, isoquinoline, phthalazine, naphthyridine, quinoxaline, quinazoline, 4H-carbazole, carbazole, β-carboline, phenanthridine, acridine, phenathroline, phenazine, imidazolidine, phenoxazine, cinnoline, pyrrolidine, pyrroline, imidazoline, piperidine, indoline, isoindoline, quinuclindine, morpholine, azocine, azepine, 2H-azepine, 1,3,5-triazine, thiazole, pteridine, dihydroquinoline, hexa methylene imine, indazole, amines, aromatic amines, polyamines, aliphatic amines, cyclo-aliphatic amines, amides, polyamides, 2-ethyl-4-methyl imidazole, 1,1,3-trichlorotrifluoroacetone, and combinations thereof. The chosen hardening agent often effects the range of temperatures over which a hardenable resin is able to cure. By way of example and not of limitation, in subterranean formations having a temperature from about 60° F. to about 250° F., amines and cyclo-aliphatic amines such as piperidine, triethylamine, N,N-dimethylaminopyridine, benzyldimethylamine, tris(dimethylaminomethyl)phenol, and 2-(N₂N-dimethylaminomethyl)phenol are preferred with N,N-dimethylaminopyridine most preferred. In subterranean formations having higher temperatures, 4,4′-diaminodiphenyl sulfone may be a suitable hardening agent. Hardening agents that comprise piperazine or a derivative of piperazine have been shown capable of curing various hardenable resins from temperatures as low as about 70° F. to as high as about 350° F. The hardening agent used is included in the consolidation fluid in an amount sufficient to consolidate the coated particulates. In some embodiments, the choice of hardening agent may depend on the particular resin chosen for the consolidation fluid. However, with the benefit of this disclosure, one of ordinary skill in the art will be able to determine an appropriate hardening agent to use with a particular resin. In some embodiments, the hardening agent may also be soluble in the aqueous base fluid or may be emulsified. Generally, the hardening agent is present in the consolidation fluid in an amount to at least partially harden the resin. In particular embodiments, the hardening agent may be present in the consolidation fluid in a stoichiometric ratio with the resin. Given a particular combination of resin and hardening agent, one of ordinary skill in the art will be able to determine an appropriate amount of hardening agent to use in a particular application.

In some embodiments of the present invention, the consolidation fluid may also include a surfactant, which facilitates the coating of the resin onto the particulates. Examples of suitable surfactants include, but are not limited to, alkyl phosphonate surfactants (e.g., a C12-C22 alkyl phosphonate surfactant), ethoxylated nonyl phenol phosphonate esters, cationic surfactants, nonionic surfactants, and mixtures of one or more cationic and nonionic surfactants. Generally, the surfactant is present in the consolidation fluid in an amount sufficient to facilitate the wetting of the proppant or other particulate matter being consolidation. In particular embodiments, the surfactant may be present in the consolidation fluid in an amount from about 0.1% w/v to about 5% w/v.

In some embodiments of the present invention may also include a silane coupling agent, which facilitates the adhesion of the resin to the particulates. Examples of suitable silane coupling agents include, but are not limited to, N-β-(aminoethyl)-γ-aminopropyl trimethoxysilane, N-2-(aminoethyl)-3-aminopropyltrimethoxysilane, 3-glycidoxypropyltrimethoxysilane, and mixtures thereof. The silane coupling agent may be included in the consolidation fluid in an amount capable of sufficiently bonding the resin to the particulate. In some embodiments of the present invention, the silane coupling agent used is included in consolidation fluid in an amount from about 0.1% w/v to about 5% w/v.

In particular embodiments, the consolidation fluids of the present invention may be foamed using a foaming agent to help divert and enhance their placement into long fractures or multiple intervals containing highly contrasting permeabilities. In such embodiments, suitable gases for use in foaming the consolidation fluid include, but are not limited to, nitrogen, carbon dioxide, air, methane, and mixtures thereof. One of ordinary skill in the art, with the benefit of this disclosure, will be able to select an appropriate gas for foaming a consolidation fluid in accordance with the teachings of the present invention. In some embodiments, the gas used to foam the consolidation fluid may be present in a consolidation fluid in an amount in the range of about 5% to about 98% by volume of the consolidation fluid. In some embodiments, the gas may be present in the consolidation fluid in an amount in the range of about 20% to about 80% by volume of the consolidation fluid. In some embodiments, the gas may be present in a consolidating fluid in an amount in the range of about 30% to about 70% by volume of the consolidation fluid.

In some embodiments comprising a foamed consolidation fluid, surfactants, such as HY-CLEAN™ (HC-2) surface-active suspending agent, PEN-5™ surface-active agent, and AQF-2™ foaming agent, all of which are commercially available from Halliburton Energy Services of Duncan, Okla., may also be added to the consolidation fluid. Additional examples of foaming agents that may be used to foam and stabilize the consolidating agent emulsions may include, but are not limited to, betaines; amine oxides; methyl ester sulfonates; alkylamidobetaines, such as cocoamidopropyl betaine; alpha-olefin sulfonate; trimethyltallowammonium chloride; C8-C22 alkylethoxylate sulfates; and trimethylcocoammonium chloride. Examples of other suitable foaming additives may be found in U.S. Pat. Nos. 7,407,916; 7,287,594; 7,124,822; 7,093,658; 7,077,219; and 7,040,419.

In particular embodiments, the amount of consolidation fluid to be used for a given treatment may be determined based on the number of perforations in the well bore and/or the length of the perforated interval to be treated. For example, in some embodiments, the consolidation fluid is generally used in an amount from about 1.25 to about 5 gallons per foot of the perforated interval to be treated. In some embodiments, the consolidation fluid is used in an amount from about 2.5 to about 5 gallons per foot of the perforated interval to be treated. This amount assumes that each foot includes approximately 2 fractures, and that each fracture is to be treated to a depth of approximately 10 feet into the fracture. Depending on the number of fractures to be treated and the depth to which it is desired to treat the fractures, more or less fluid may be used. With the benefit of this disclosure, one of ordinary skill in the art should be able to determine a suitable amount of fluid to use to treat a particular subterranean formation.

In some embodiments, the application of the consolidation fluid may be preceded by the application of a pre-flush fluid. Such a pre-flush fluid may help to remove debris from the flow path, displace reservoir fluids, and/or precondition the surface of the proppant or gravel for accepting the resin coating in the consolidation fluid. Examples of suitable pre-flush fluids include aqueous and solvent-based fluids. In some embodiments, aqueous pre-flush fluid may comprise fresh water, saltwater (e g., water containing one or more salts dissolved therein), brine (e.g., saturated saltwater), seawater, or combinations thereof, and may be from any source, provided that they do not contain components that might adversely affect the stability and/or performance of the consolidation fluids of the present invention. In other embodiments, solvent-based fluids may comprise a glycol ether solvent, such as diethylene glycol monomethyl ether, diethylene glycol dimethyl ether, ethylene glycol monobutyl ether, or dipropylene glycol monomethyl ether.

The pre-flush fluids may also comprise a surfactant. Examples of suitable surfactants include, but are not limited to, alkyl phosphonate surfactants (e.g., a C12-C22 alkyl phosphonate surfactant), ethoxylated nonyl phenol phosphonate esters, cationic surfactants, nonionic surfactants, and mixtures of one or more cationic and nonionic surfactants. Examples of suitable, commercially available surfactants include 19N™ surfactant and ES-5™ surfactant, both available from Halliburton Energy Services, Inc., of Duncan, Okla. In some embodiments, the surfactant may be present in an amount from about 0.1% to about 3% by volume of the pre-flush fluid. In particular embodiments, the surfactant may be present in an amount of about 0.5% by volume of the pre-flush fluid. In some embodiments, the pre-flush fluid may be applied in an amount from about 1 to about 6 times the volume of the consolidation fluid. In particular embodiments, the pre-flush fluid is applied in an amount of about 3 times the volume of the consolidation fluid.

In some embodiments, application of the consolidation fluid may be followed by the application of a post-flush fluid. Such a post-flush fluid may help remove excess consolidation fluid from the pore spaces between the particulates and/or reduce permeability loss in the consolidated pack. Examples of suitable post-fluid fluids include, but are not limited to, gases, such air and nitrogen, foamed aqueous fluids, such as brine, and hydrocarbon fluids, such as diesel and kerosene. In particular embodiments where a gaseous post-flush fluid is applied, the fluid may be applied in an amount from about 25 to about 200 cubic feet per foot of perforated interval to be treated depending on the temperature and pressure at the interval of interest. In other embodiments, where a foamed post-flush fluid is applied, the fluid may be applied in an amount from about one to two times the volume of the consolidation fluid applied. With the benefit of this disclosure, one of ordinary skill in the art should be able to determine an appropriate amount of post-flush fluid to apply in a given consolidation treatment.

The consolidation fluid, pre-flush, and post-flush fluids of the present invention may be prepared by any method suitable for a given application. For example, certain components of the consolidation fluid of the present invention may be provided in a pre-blended powder or a dispersion of powder in a nonaqueous liquid, which may be combined with an aqueous base fluid at a subsequent time. After the preblended powders and aqueous base fluid have been combined, other suitable additives may be added prior to introduction into the well bore. Those of ordinary skill in the art, with the benefit of this disclosure will be able to determine other suitable methods for the preparation of the treatments fluids of the present invention.

In general, the consolidation, pre-flush, and/or post-flush fluids of the present invention may be bullheaded into the well, i.e., pumped into the well bore without the use of isolation tools or barrier devices under the assumption that the fluid will be placed into a target area, or placed using coiled tubing or jointed pipe to treat intervals of interest. In some embodiments, mechanical isolation devices and packers may be used in combination with coiled tubing or jointed pipe to divide the well bore into shorter intervals. A pressure pulsing tool or rotating jetting tool may also be coupled with the coiled tubing or jointed pipe to enhance the placement of the fluid into an interval. For example, a pressure pulsing tool based on fluid-oscillation may be used to create pulsating pressure waves within the well bore and formation fluids to enhance the penetration of the treatment fluids further into the fractures and formations.

After application of the consolidation fluid and any pre-flush or post-flush fluids, the well may be shut in for a period of time to allow the resin applied to cure. The amount of time necessary for the resin to cure sufficiently may depend on temperature and/or the composition of the resin. In some embodiments, positive pressure may be maintained in the well bore during shut in to prevent or reduce fluid swabbing into the well bore from the formations surrounding the well bore. Similarly, positive pressure may be maintained in the well bore during the removal of the equipment used to place the consolidation, pre-flush, and/or post-flush fluids to similarly prevent or reduce fluid swabbing. After the resin has sufficiently cured, the well may be returned to production.

As stated above, the methods of the present invention may be employed in any subterranean treatment where unconsolidated particulates reside in the formation. These unconsolidated particulates may comprise, among other things, sand, gravel, fines and/or proppant particulates within the open space of one or more fractures in the subterranean formation (e.g., unconsolidated particulates that form a proppant pack or gravel pack within the formation). Using the consolidation fluids and methods of the present invention, the unconsolidated particulates within the formation may be remedially treated to consolidate the particulates into a cohesive, consolidated, yet permeable pack and minimize or reduce their production with production fluids. For example, in some embodiments, the consolidation fluid, pre-flush fluid, and/or post-fluid fluid may be applied to remedially treat a gravel pack or frac-packs that has failed due to screen damage (often caused by screen erosion) to reduce the production of gravel, proppant, or formation sand with the production fluid.

In one embodiment, the present invention provides a method of treating a subterranean formation comprising introducing a consolidation fluid comprising an aqueous base fluid, an emulsified resin, and a hardening agent into a subterranean formation comprising unconsolidated particulates; wherein the emulsified resin is emulsified prior to being introduced into the aqueous base fluid; and allowing the resin to cure to at least partially consolidate the unconsolidated particulates. In another embodiment, the present invention provides a method of treating a subterranean formation comprising introducing a pre-flush fluid into a subterranean formation comprising unconsolidated particulates; introducing a foamed consolidation fluid comprising an aqueous base fluid, an emulsified resin, a hardening agent, a silane coupling agent, and a surfactant into the subterranean formation subsequent to the pre-flush fluid; wherein the emulsified resin is emulsified prior to being introduced into the aqueous base fluid; and allowing the resin to cure to at least partially consolidate the unconsolidated particulates.

To facilitate a better understanding of the present invention, the following examples of specific embodiments are given. In no way should the following examples be read to limit or define the entire scope of the invention.

### EXAMPLE 1

In order to demonstrate the effectiveness of remedial treatments in accordance with particular embodiments of the present invention, seven simulated proppant packs were prepared using 5-inch long brass cells with 1.38-inch inner diameters. A 60-mesh wire screen was installed at the bottom of each cell, and 250 grams of a selected proppant material were slowly poured into the cell while the sidewalls of the cells were tapped to facilitate uniform packing of the proppant.

Each simulated proppant pack was saturated and pre-flushed with 3 pore volumes (120 mL) of 3% KCl brine containing 0.5% 19N™ surfactant. Each proppant pack was then injected with 2 pore volumes (80 mL) of a consolidation fluid mixture comprising 13% v/v EPI-REZ™ 3510-W60, a water-based emulsified resin commercially available from Hexion Specialty Chemicals, Inc. of Columbus, Ohio; 6.5% v/v ANQUAMINE® 401, a hardening agent commercially available from Air Products and Chemicals, Inc. of Allentown, Pa.; 0.5% v/v EWA-1™, an epoxy wetting surfactant commercially available from Halliburton Energy Services, Inc. of Duncan, Okla.; 1% v/v ES-5™, a cationic surfactant also commercially available from Halliburton Energy Services, Inc. of Duncan, Okla.; 0.5% v/v SILQUEST® A-1120 Silane, a silane coupling agent commercially available from Momentive Performance Materials Inc. of Wilton, Conn.; and the remainder 3% KCl brine. After application of the consolidation fluid, the proppant packs were post-flushed with nitrogen gas until no liquid came out of the proppant packs. The treated proppant packs were then cured at a predetermined curing temperature for a predetermined duration. The retained permeabilities of the consolidated packs were then determined by injecting the packs with a large volume of brine until a stable flow rate was obtained. Next, the maximum pump rates at which the packs remain stable, i.e., without allowing sand or proppant to produce out, were determined. Lastly, the consolidated packs were cut into core size and their unconfined compressive strengths (“UCS”) were determined. The results of these tests are shown below in Table 1.

TABLE 1

| | | | | | Retained | Water Flow |
|---|---|---|---|---|---|---|
| | Proppant | Curing | Curing Time | | Permeability | Rate |
| Sample No. | Material | Temp. (° F.) | (hr) | UCS (psi) | (%) | (BPD/perf) |
| 1 | 20/40-mesh | 125 | 48 | 15 | >95 | 130* |
| | Brady | | | | | |
| 2 | 20/40-mesh | 150 | 48 | 80 | >95 | >275** |
| | Brady | | | | | |
| 3 | 20/40-mesh | 175 | 48 | 200 | >95 | >275** |
| | Brady | | | | | |
| 4 | 20/40-mesh | 200 | 48 | 350 | >95 | >275** |
| | Brady | | | | | |
| 5 | 20/40-mesh | 200 | 20 | 185 | >95 | >275** |
| | Brady | | | | | |
| 6 | 20/40-mesh | 200 | 20 | 160 | >95 | >275** |
| | CarboLite | | | | | |
| 7 | 20/40-mesh | 200 | 20 | 70 | >95 | >275** |
| | Bauxite HSP | | | | | |

*Flow rate when sand or proppant begins to produce out
**Pump exceeded allowable pressure

As shown in Table 1, all seven samples exhibited retained permeabilities of at least 95%. Furthermore, all of the samples except sample no. 1, which had the lowest curing temperature, exhibited maximum pump rates of at least 275 BPD/perf, at which point the pump exceeded its maximum allowable pressure. Samples no. 1-4 also illustrate that increasing the curing temperature of samples generally resulted in higher UCSs of the consolidated proppant packs. For example, sample no. 1, with a curing temperature of 125° F., exhibited a UCS of 15 psi; sample no. 2, with a curing temperature of 150° F., exhibited a UCS of 80 psi; sample no. 3, with a curing temperature of 175° F., exhibited a UCS of 200 psi; and sample no. 4, with a curing temperature of 200° F., exhibited a UCS of 350 psi. Samples no. 4 and 5 also demonstrate that increasing the curing time from 20 hours to 48 hours, at a curing temperature of 200° F., increased the UCS from 185 psi to 350 psi. Lastly, samples no. 5-7 demonstrate the effect of different proppant materials on the properties of the consolidated proppant packs. Although all three exhibited maximum pump rates of at least 275 BPD/perf and retained permeabilities of over 95%, sample no. 5, with Brady sand, exhibited a UCS of 185 psi; sample no. 6, with CarboLite proppant, exhibited a UCS of 160 psi; and sample no. 7, with Bauxite HSP proppant, exhibited a UCS of 70 psi.

### EXAMPLE 2

In another series of experiments, 20/40-mesh Brady sand was used to pack brass cells as described above in Example 1. The initial permeability of each sand pack was determined using tap water. The sand packs were then put into a 125° F. oven for 3 hours. Heat tape was then wrapped around each brass cell to help maintain its temperature at 125° F. during the consolidation treatment. Each sand pack was pre-flushed with 120 mL of a 3% KCl brine solution containing 0.5% 19N™ surfactant, and then treated with 80 mL of a consolidation fluid comprising either 3% w/v or 6% w/v emulsified resin prepared as described above in Example 1. These fluids were injected into the sand pack, either as a liquid or as a foamed fluid, using a peristaltic pump. For the foamed treatments, 80 mL of the liquid consolidation fluid was blended with 1.2 mL of HC-2 foaming agent using a Waring blender, starting at low speed and continuing until a uniform foam was obtained and maintained at high speed for 10 seconds. After application of the consolidation fluid, some of the sand packs were post-flushed with either nitrogen gas at a flow rate of 12 L/min or a foamed fluid prepared from 3% KCl brine and HC-2 foaming agent; other sand packs received no post-flush. The brass cells were then sealed and cured in an oven at either 125° F. for 48 hours or 150° F. for 17 hours. Afterward, the sand packs were subjected to retained permeability measurements using tap water, UCS measurements, and tensile strength measurements, the results of which are illustrated below in Table 2.

TABLE 2

| | | | | | | | Tensile |
|---|---|---|---|---|---|---|---|
| Test | Consolidation | | Curing | Curing | Retained | UCS | Strength |
| No. | Treatment | Post-Flush | Temp (° F.) | Time (Hrs) | Permeability (%) | (psi) | (psi) |
| 1 | 6% resin, | None | 125 | 48 | 70 | 127 | 24 |
| | foamed | | | | | | |
| 2 | 6% resin, | 3% KCl, | 125 | 48 | 82 | 0 | 0 |
| | foamed | foamed | | | | | |
| 3 | 6% resin, | Nitrogen gas, | 125 | 48 | 86 | 24 | 5 |
| | liquid | 3 min @ 12 L/min | | | | | |
| 4 | 6% resin, | 3% KCl, | 125 | 48 | 77 | 0 | 0 |
| | liquid | foamed | | | | | |
| 5 | 3% resin, | 3% KCl, | 125 | 48 | 97 | 0 | 0 |
| | foamed | foamed | | | | | |
| 6 | 6% resin, | Nitrogen gas, | 150 | 17 | 98 | 22 | 13 |
| | foamed | 2 min @ 12 L/min | | | | | |
| 7 | 6% resin, | Nitrogen gas, | 150 | 17 | 94 | 5 | 3 |
| | foamed | 4 min @ 12 L/min | | | | | |
| 8 | 3% resin, | Nitrogen gas, | 150 | 17 | 94 | 0 | 0 |
| | foamed | 2 min @ 12 L/min | | | | | |
| 9 | 3% resin, | None | 150 | 17 | 92 | 13 | 4 |
| | foamed | | | | | | |

As shown in Table 2, each consolidated sand pack exhibited a retained permeability of at least 70%. In fact, each sand pack cured at over 150° F. exhibited a retained permeability of at least 92%, with test no. 6 exhibiting a retained permeability of 98%. The tests also illustrate the effectiveness the consolidation treatment even when used without a post-flush fluid. Although the use of a post-flush fluid generally resulted in higher retained permeabilities, test no. 9, which forewent a post-flush, still exhibited a regained permeability of 92%, a UCS of 13 psi, and a tensile strength of 4 psi. It is believed that the resin-treated sand packs cured at 150° F. with longer curing times should obtain higher UCS and tensile strength values.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. While numerous changes may be made by those skilled in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A consolidation fluid comprising:
an aqueous base fluid;
an emulsified resin;
a hardening agent;
a silane coupling agent; and
a surfactant;
wherein the emulsified resin is emulsified prior to being introduced into the aqueous base fluid.

2. The consolidation fluid of claim 1, wherein the emulsified resin is selected from the group consisting of epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof.

3. The consolidation fluid of claim 1, wherein the silane coupling agent is selected from the group consisting of N-β-(aminoethyl)-γ-aminopropyl trimethoxysilane, N-2-(aminoethyl)-3-aminopropyltrimethoxysilane, 3-glycidoxypropyltrimethoxysilane, and mixtures thereof.

4. The consolidation fluid of claim 1, wherein the surfactant is selected from the group consisting of alkyl phosphonate surfactants, ethoxylated nonyl phenol phosphonate esters, cationic surfactants, nonionic surfactants, and mixtures of one or more cationic and nonionic surfactants.

5. A method of treating a subterranean formation, comprising:
introducing a consolidation fluid comprising an aqueous base fluid, an emulsified resin, and a hardening agent into a subterranean formation comprising unconsolidated particulates;
wherein the emulsified resin is emulsified prior to being introduced in the aqueous base fluid; and
allowing the resin to cure to at least partially consolidate the unconsolidated particulates.

6. The method of claim 5, wherein the resin is selected from the group consisting of epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof.

7. The method of claim 5, wherein the consolidation fluid further comprises a silane coupling agent selected from the group consisting of N-β-(aminoethyl)-γ-aminopropyl trimethoxysilane, N-2-(aminoethyl)-3-aminopropyltrimethoxysilane, 3-glycidoxypropyltrimethoxysilane, and mixtures thereof.

8. The method of claim 5, wherein the consolidation fluid further comprises a surfactant selected from the group consisting of alkyl phosphonate surfactants, ethoxylated nonyl phenol phosphonate esters, cationic surfactants, nonionic surfactants, and mixtures of one or more cationic and nonionic surfactants.

9. The method of claim 5, further comprising introducing a pre-flush fluid into the subterranean formation prior to the introduction of the consolidation fluid.

10. The method of claim 8, wherein the pre-flush fluid comprises fresh water, saltwater, brine, seawater, diethylene glycol monomethyl ether, diethylene glycol dimethyl ether, ethylene glycol monobutyl ether, dipropylene glycol monomethyl ether, or combinations thereof.

11. The method of claim 10, wherein the pre-flush fluid further comprises a surfactant selected from the group consisting of alkyl phosphonate surfactants, ethoxylated nonyl phenol phosphonate esters, cationic surfactants, nonionic surfactants, and mixtures of one or more cationic and nonionic surfactants.

12. The method of claim 5, further comprising introducing a gaseous or foamed post-flush fluid into the subterranean formation subsequent to the introduction of the consolidation fluid.

13. The method of claim 5, further comprising maintaining a positive pressure on the subterranean formation while allowing the resin to cure.

14. The method of claim 5, wherein the consolidation fluid comprises a foamed fluid.

15. A method of treating a subterranean formation, comprising:
introducing a pre-flush fluid into a subterranean formation comprising unconsolidated particulates;
introducing a foamed consolidation fluid comprising an aqueous base fluid, an emulsified resin, a hardening agent, a silane coupling agent, and a surfactant into the subterranean formation subsequent to the pre-flush fluid;
wherein the emulsified resin is emulsified prior to being introduced into the aqueous base fluid; and
allowing the resin to cure to at least partially consolidate the unconsolidated particulates.

16. The method of claim 15, further comprising introducing a gaseous or foamed post-flush fluid into the subterranean formation subsequent to the introduction of the consolidation fluid.

17. The method of claim 15, wherein the resin is selected from the group consisting of epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof.

18. The method of claim 15, wherein the silane coupling agent is selected from the group consisting of N-β-(aminoethyl)-γ-aminopropyl trimethoxysilane, N-2-(aminoethyl)-3-aminopropyltrimethoxysilane, 3-glycidoxypropyltrimethoxysilane, and mixtures thereof.

19. The method of claim 15, wherein the pre-flush fluid comprises fresh water, saltwater, brine, seawater, diethylene glycol monomethyl ether, diethylene glycol dimethyl ether, ethylene glycol monobutyl ether, dipropylene glycol monomethyl ether, or combinations thereof.

20. The method of claim 19, wherein the pre-flush fluid further comprises a surfactant selected from the group consisting of alkyl phosphonate surfactants, ethoxylated nonyl phenol phosphonate esters, cationic surfactants, nonionic surfactants, and mixtures of one or more cationic and nonionic surfactants.
